(19) United States
(12) Patent Application Publication
(10) Pub. No.: US 2026/0326497 A1
(43) Pub. Date: Oct. 22, 2026

(54) FOOTPOINT ADJUSTMENT DEVICE WITH ACTUATORS, SHOCK ABSORBER, AND ARRANGEMENT

(71) Applicant: Vibracoustic SE, Weinheim (DE)

(72) Inventors: Ersan Altinoluk, Hamburg (DE); Dieter Bulling, Wedemark (DE); Sebastian Volkmann, Vögelsen (DE)

(21) Appl. No.: 19/452,644

(22) Filed: Jan. 19, 2026

(30) Foreign Application Priority Data
Jan. 20, 2025 (DE) 10 2025 101 863.4

(51) Int. Cl. B60G 17/027; B60G 15/06

(52) U.S. Cl. CPC B60G 17/0272; B60G 15/063; B60G 2202/312; B60G 2204/1242; B60G 2204/62; B60G 2500/20; B60G 2800/162; B60G 2800/916

(57) ABSTRACT

The proposal is for a foot point adjustment device (2), through which a damper longitudinal axis (Z2) can pass, comprising a first actuator (10) having a first actuator longitudinal axis (Z10) and a second actuator (20) having a second actuator longitudinal axis (Z20).

The invention relates to a foot point adjustment device having a plurality of actuators according to claim 1, a suspension strut and an assembly.

Foot point adjustment devices for suspension struts are known in practice. The foot point adjustment device is used to adjust the height of a spring plate on which a spring of the suspension strut is supported. Height adjustment is accomplished by means of a single actuator, which is arranged circumferentially or else laterally with respect to an inserted damper of the suspension strut. If there is no damper present, a single actuator is generally arranged in such a way with respect to the spring that the spring and the actuator have approximately the same central longitudinal axis.

MacPherson suspension struts are likewise known. They generally comprise a damper which is connected firmly to a wheel carrier and which is located laterally at a short distance from the tyre and the rim thereof. The spring plate is mounted firmly on the damper tube. The spring is supported on the body between the spring plate and a suspension strut tower, wherein a rotational degree of freedom is provided on the spring tower, e.g. by an axial bearing.

On account of their bulky construction, previously known foot point adjustment devices are not suitable for use in the restricted space conditions associated with MacPherson suspension struts. Moreover, the single actuator can give rise to disadvantageous tilting moments if it is arranged laterally with respect to the damper. In addition, known foot point adjustment devices are in need of improvement as regards load distribution.

The corresponding improvement of the prior art is therefore the object of the invention.

Features according to the invention are indicated in claims 1 and 12. The disclosure refers to refinements, in particular in claims 2 to 11.

According to the invention, the proposal is for a foot point adjustment device, through which a damper longitudinal axis can pass, comprising a first actuator having a first actuator longitudinal axis and a second actuator having a second actuator longitudinal axis.

The invention can also refer to an assembly comprising the foot point adjustment device according to the disclosure and the/a damper. Thus, a foot point adjustment device is created which, instead of a single bulky actuator surrounding a damper at the outer circumference, provides two actuators. The two actuators can be arranged or arrangeable next to a damper instead of surrounding it at the outer circumference. The damper can be arranged to the outside of the actuators. Thus, the provision of two actuators not only allows a compact overall construction. The proposed foot point adjustment device can also be implemented without significantly increasing costs over a single but larger and more complex actuator. The foot point is a common foot point for the two actuators.

The foot point adjustment device can be for a suspension strut. The foot point adjustment device enables adjustment of the foot point without running the risk that there will be a collision in terms of installation space with a tyre and/or a rim. In this arrangement, the foot point adjustment device can be connected firmly to the damper. The damper can be connected firmly to a wheel carrier. Thus, the foot point adjustment device can be firmly fixed with respect to the wheel carrier, thus enabling both of them to move together during steering or during comparable rotational movements. This reliably prevents a collision in terms of installation space between the foot point adjustment device and the tyre and/or a rim.

Using two actuators, which can be arranged next to a damper, reduces tilting moments acting on the individual actuator as compared with a single actuator. As a result, the two actuators can each be made smaller.

In addition, the required actuating pressure can be reduced with two actuators since the required pressure for a given vehicle load increases as the projected area decreases. A lower pressure, in turn, leads to a more robust system or bellows which can be constructed at lower cost and the bursting pressure of which is lower as compared with a system which uses a single actuator instead of two actuators of the same size. Alternatively, if the pressure used is the same, the two actuators can each have just half the projected area of a single actuator, leading to a significantly slimmer design. It is precisely such a slim design of the two actuators which makes it possible to satisfy the difficult installation space requirements of the MacPherson suspension strut.

It is therefore conceivable for each of the two actuators to be arranged radially adjacent to the damper (or not to be traversed by the damper/not to be arranged around the outer circumference of the damper). This leads to a slim design of the actuators since the actuator does not have to maintain an internal installation space for the damper. The outside diameter of at least one actuator, preferably of both actuators, amounts to at most three times the outside diameter of the damper at the level of the actuators, preferably at most twice the outside diameter, as a further preference at most one and a half times the outside diameter.

The first actuator and the second actuator are separate actuators. The damper longitudinal axis can extend parallel to the direction of adjustment of the foot point adjustment device. It is thereby possible to reduce the installation space requirement overall.

The two actuators can be hydraulic actuators. On each of the two actuators, a variable-volume fluid space which allows a defined target height to be adopted can be created by means of a bellows. Each of the two actuators can comprise a housing and/or a supporting tube. Each of the two actuators can comprise an attachment plate, and these can be connected to one another via an adjusting plate. The adjusting plate can be adjustable along the damper longitudinal axis. Each of the two actuators can be fastened to a fixing plate. The fixing plate can be firmly fixed on the damper or can be firmly fixed with respect to the damper. This prevents unwanted twisting around the damper longitudinal axis. Each actuator can comprise a bellows, preferably a rolling bellows. Each bellows can delimit a fluid space. Each fluid space can be delimited exclusively by the attachment plate and/or adjusting plate, the fixing plate and/or the rolling piston and the bellows. At one end, each bellows can be fastened to the attachment plate and/or the adjusting plate and/or the supporting tube by way of a first bellows fastening. At the other end, each bellows can be fastened to the fixing plate and/or the rolling piston and/or the supporting tube by way of a second bellows fastening. Each bellows can form a rolling fold and/or a stationary fold. Each of the two actuators can comprise a rolling piston, on which the respective bellows rolls. The rolling piston can be fastened to the fixing plate. Each of the two actuators can comprise a valve for filling and emptying the fluid space. The bellows fastenings can comprise a clamping ring, which fixes the bellows.

The suspension strut can be a MacPherson suspension strut. The suspension strut can comprise a damper, a spring and a spring plate. The damper can be connected or connectable to a wheel carrier. A wheel carrier can be attached or attachable to the damper. The spring plate can be arranged on the damper. The spring can be supported on a body between the spring plate and a suspension strut tower. Where the disclosure refers to a “damper”, this can refer to the damper of the suspension strut. The spring can be a coil spring. The suspension strut can guide the wheel (tyre and rim)-in contrast to “spring-damper units”, which are sometimes referred to as “suspension struts” but, in contradistinction to suspension struts, especially MacPherson struts, do not guide the wheel.

According to one further development, the two actuator longitudinal axes can be arranged parallel to one another. As a result, both actuators can jointly define a direction of adjustment of the foot point adjustment device. The two actuator longitudinal axes can furthermore both be arranged radially offset with respect to the damper longitudinal axis. Both actuator longitudinal axes and the damper longitudinal axis preferably run parallel to one another.

According to one embodiment, the two actuator longitudinal axes can be arranged diametrically with respect to the damper longitudinal axis. This makes it possible to provide a uniform foot point adjustment device.

According to one embodiment, the two actuator longitudinal axes and the damper longitudinal axis can form a triangle in cross section. The two sides of the triangle between each of the damper longitudinal axes and the actuator longitudinal axis can enclose an angle in the range of from 179° to 160°. As a result, the two actuators can be placed further away from a tyre and/or a rim. A larger radial clearance can be created. The tyre and/or the rim can lie diametrically opposite the triangle with respect to the damper longitudinal axis.

According to one further development, the two actuators can be at a radial distance from one another. The two actuators can form an intermediate space. A damper can be arranged in the intermediate space. The actuators are of simpler construction than in the prior art since the damper can be taken past the actuators. This eliminates the complex requirement for the previously necessary sealing of the fluid space of the actuator with respect to the damper passing through the actuator. Each actuator can have a separate housing. The radial distance can be the smallest distance between the actuators or housings.

According to one embodiment, the two actuators can be connected in parallel. This enables them to act jointly. The parallel connection can be effected structurally by means of a fixing plate and an adjusting plate. The actuators can be arranged between the plates and can thereby be positively coupled.

According to one further development, the two actuators can be connected to a fixing plate, the fixing plate preferably being fastened or fastenable to a damper. The foot point adjustment device comprises the fixing plate. The two actuators are supported against the fixing plate. The fixing plate can be a common fixing plate for the two actuators. It is thereby possible to reduce a number of components and tilting moments.

According to one further development, the two actuators can be connected to an adjusting plate, the adjusting plate preferably being guided or guidable in such a way as to be adjustable along the damper longitudinal axis. The foot point adjustment device comprises the adjusting plate. The two actuators are supported against the adjusting plate. The adjusting plate can be a common adjusting plate for the two actuators. It is thereby possible to reduce a number of components and tilting moments. Another advantage is that the adjusting plate takes over the radial guidance of the actuators in that it is supported radially on the damper.

According to one embodiment, the adjusting plate can be connected firmly to a spring plate. The adjustment of the adjusting plate by the actuators then also leads directly to the adjustment of the spring plate. The adjusting plate and the spring plate can be fastened to an adjusting sleeve for joint adjustment. The adjusting sleeve can be traversed by the damper.

According to one embodiment, the adjusting plate can comprise a sliding means. The sliding means can be a bearing. The sliding means can support the adjusting plate in a sliding manner on the damper or on a central guide element surrounding the damper. The sliding means can be arranged in a cylindrical section of the adjusting plate. The cylindrical section prevents tilting or canting of the adjusting plate.

According to one further development, a respective attachment plate can be fastened to the adjusting plate for each of the two actuators. The foot point adjustment device comprises the attachment plates. The attachment plates are fastened to the adjusting plate and are thus adjustable. This allows functional separation in a modular sense. While the adjusting plate serves primarily for guidance during the adjustment and transmission of the adjusting movement to the spring plate, the attachment plates can serve for attachment to the bellows.

The adjusting plate can thus be a shared component which can be used for bellows and attachment plates of different configurations, while bellows of different configurations can each be assigned to one attachment plate. These attachment plates can differ depending on the bellows. Moreover, the actuators can be produced separately and then assembled to give the foot point adjustment device. Modular production allows the use of simple and low-cost tools.

According to one further development, the two actuators can be structurally identical. By means of identical actuators it is possible to ensure uniform adjustment. In addition, the identical design increases the number of shared components, leading to a low-cost assembly overall.

According to one further development, each of the two actuators can comprise a bellows, preferably a single bellows. By virtue of the fact that the fluidic space does not have to be sealed with respect to the damper radially on the inside (relative to the respective actuator longitudinal axis), a single bellows per actuator is sufficient. The bellows can delimit the fluid space at the inner and outer circumference. In this case, the bellows can fully delimit the fluid space at the outer circumference. At the inner circumference, the bellows can partially delimit the fluid space, e.g. where it rests against the rolling piston.

According to one embodiment, the stationary fold of the bellows can be arranged around the outer circumference of the first bellows fastening. The fluid space can be arranged on the outer circumference of the first fastening, with the result that the internal pressure of the fluid space presses on the first fastening. This leads to particularly secure clamping. This makes the seal particularly robust.

According to one embodiment, one fold seat, against which the stationary fold rests, can be provided per actuator. The fold seats can be formed by the respective attachment plate. The fold seats can be formed by the adjusting plate. By virtue of the fact that the stationary fold rests against the fold seat, the supporting force of the foot point adjustment device is also introduced into the fold seat. The fold seat can comprise an annular surface. The annular surface can be delimited (with respect to the respective actuator longitudinal axis) radially on the inside by the first bellows fastening and radially on the outside by the contact end between the stationary fold and the adjusting plate or attachment plate. The annular surface can be an arched annular surface. This creates a large area for force transmission. This leads to an advantageous pressure distribution in the components and thus to a robust configuration.

According to one further development, each of the two actuators can comprise a supporting tube, the respective bellows preferably being supported at the outer circumference by the respective supporting tube. This prevents inflation of the bellows, which would expand the diameter. The supporting tube can be the housing of the actuator.

According to one embodiment, the supporting tube can be fastened to the adjusting plate and/or the bellows and/or the attachment plate. The supporting tube can be adjustable relative to the fixing plate and/or to the rolling piston. As a result, the protection of the bellows at the outer circumference is independent of the set height of the foot point adjustment device.

According to one embodiment, each of the bellows can at least partially, preferably completely, delimit a space which is/can be filled with an incompressible fluid, the fluid preferably being in a liquid state of aggregation in the range of from −30° C. to +90° C. The large temperature range of the liquid state of aggregation entails a corresponding large temperature interval for use, which allows use in most motor vehicles.

According to one further development, each of the two actuators can comprise a rolling piston, the respective rolling piston preferably forming a sliding bearing assembly with the corresponding supporting tube. The supporting tube can preferably be provided with sliding support on the rolling piston. As a result, each actuator can be guided in the radial direction. The supporting tube can have a free end, into which the rolling piston enters, wherein the supporting tube and the rolling piston can be provided with sliding support relative to one another. Secure positioning of the supporting tube is thereby ensured.

According to one embodiment, the rolling piston can have a bulging section, the outside diameter of which is larger in a region which is located adjacent to the rolling fold of the corresponding bellows along the respective actuator longitudinal axis than the zenith of the rolling fold. The diameter of the bulging section can be so large that the supporting tube forms a supporting clearance fit with the bulging section. Since the supporting tube can be embodied at particularly low-cost if its free end and the section in which the bellows is supported have the same diameter, it is advantageous if the bulging section has approximately the inside diameter of the supporting tube in order to form the sliding bearing.

According to one embodiment, at least one end stop can be provided for the actuators. Each actuator can comprise an end stop. In the position of the actuator in the end stop, the distance between the supporting tube and the fixing plate can be at most 10 mm. This defines a minimum position of the foot point adjustment device which ensures that the supporting tube is not exposed to any significant axial forces. As a result, the supporting tubes can be embodied with thin walls and can thus be light and inexpensive. The foot point adjustment device cannot achieve a lower position. The end stop can be formed by stop surfaces of the rolling piston and of the attachment plate. In the position of the actuator in the end stop, the rolling piston and the attachment plate can rest against one another.

According to one further development, the fixing plate can be connected firmly to the damper. The damper, for its part, can be connected firmly to the wheel carrier. This prevents an unwanted rotation of the two actuators around the damper longitudinal axis and collision with the tyre/rim. The firm connection can be indirect or direct.

According to one embodiment, the foot point adjustment device can comprise one valve and/or one hose connector per actuator. The valve and/or the hose connector can be fastened firmly to the fixing plate. As a result, the feed line is not subject to any movement produced by an adjustment of the foot point adjustment device. This saves materials.

The disclosure furthermore includes a suspension strut having a foot point adjustment device according to the disclosure, wherein the actuators are arranged radially adjacent with respect to the damper. The suspension strut can be a MacPherson suspension strut. The advantages already described above in respect of the foot point adjustment device are also obtained analogously for the suspension strut, these being incorporated by reference.

According to one embodiment, the foot point adjustment device can be arranged on one side of a spring plate, and a spring can be arranged on the other side of the plate. The foot point adjustment device can be arranged in a space-saving manner below the spring plate and next to the tyre/rim in the horizontal direction (in each case based on an installed position in the motor vehicle).

According to the invention, there is furthermore a proposal for an assembly comprising a foot point adjustment device in accordance with the disclosure and a tyre having a side wall and a rim, wherein the two actuators and the damper are arranged radially adjacent to the side wall and/or the rim, and each has a radial clearance with respect to the side wall and/or the rim of at least 10 mm, preferably of at least 15 mm. As a result, the foot point adjustment device can be placed very close to the wheel, making use of the installation space. The radial clearances can be different or identical.

The advantages already described above in respect of the foot point adjustment device and the suspension strut are also obtained analogously for the assembly, these being incorporated by reference. The two individual actuators can be less complex and can be placed next to the damper in such a way that the installation space is not significantly restricted in the direction of the wheel carrier and/or in the direction of the tyre/rim. Here, positioning can be performed in such a way that a minimum distance of 10 mm can be maintained between the actuators and the tyre/rim. As an alternative to the foot point adjustment device, the assembly can comprise a suspension strut in accordance with the disclosure having a foot point adjustment device. The radial clearance can be the smallest distance between the side wall and/or rim, on the one hand, and the corresponding actuator and/or damper, on the other hand. The tyre is mounted on a rim. The tyre and the rim define a wheel. The wheel has an axis of rotation about which it rotates as it rolls. The wheel has a steering axis about which it rotates during steering. The radial clearance/smallest distance can be parallel to the axis of rotation of the tyre. It is conceivable that the radial clearance between the side wall and/or rim, on the one hand, and the corresponding actuators, on the other hand, is larger than the radial clearance between the side wall and/or rim, on the one hand, and the damper, on the other hand. As a result, the two actuators can be placed further away from a tyre and/or a rim. A larger radial clearance can be created. The axis of rotation of the tyre and the damper longitudinal axis can intersect. This promotes a centred arrangement. The actuator longitudinal axes can lie opposite one another relative to the axis of rotation of the tyre. The side wall faces the foot point adjustment device.

A foot point adjustment device for a (single) suspension strut is disclosed. An assembly which comprises a (single) foot point adjustment device in accordance with the disclosure is disclosed.

The terms “radially adjacent”, “next to” and “alongside” can be used synonymously. The terms “radial” and “radial direction” relate to one or more disclosed axes. If components are disclosed in multiple instances, refinements and advantages which are described only for one of the components apply as it were also optionally to the other corresponding components. Axial and the axial direction are parallel to the longitudinal axis. Radial and the radial direction are perpendicular to the longitudinal axis. The circumference and the circumferential direction run around the longitudinal axis. The advantages described are obtained especially within the range limits stated, but the advantages may also be present outside one or both specific range limits, if only in an attenuated way.

Further features, details and advantages of the invention will emerge from the wording of the claims and from the following description of exemplary embodiments with reference to the drawings. In the drawings:

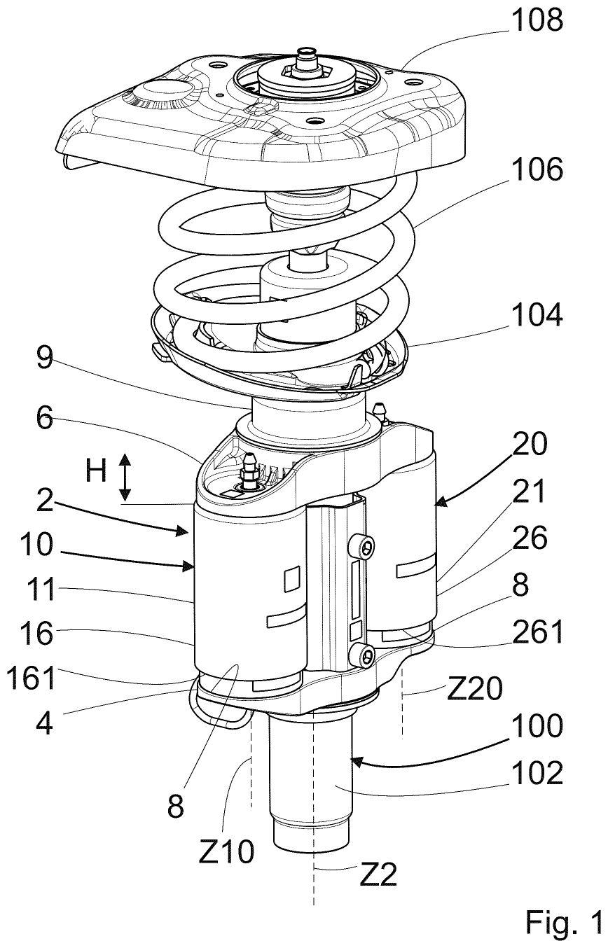

FIG. 1 shows a perspective view of a suspension strut,

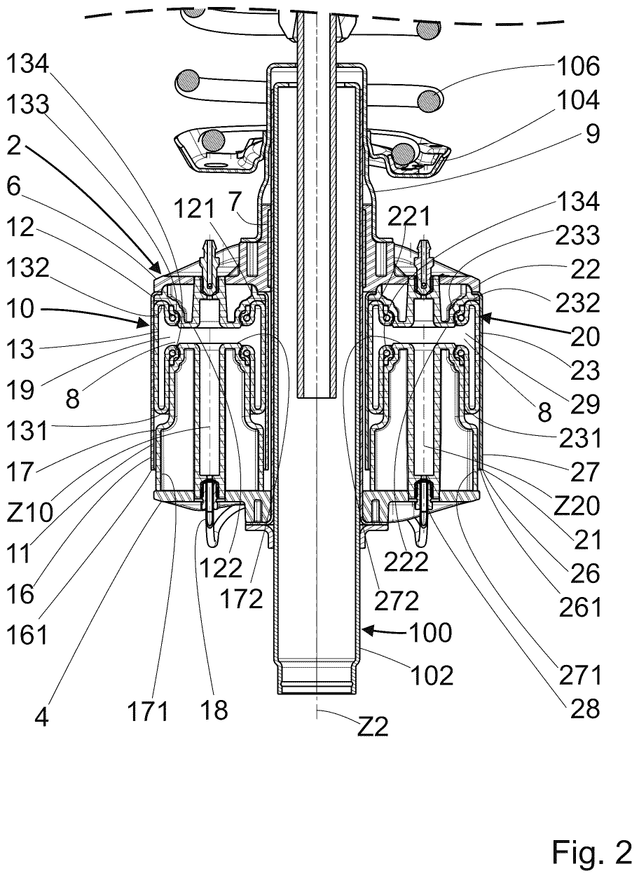

FIG. 2 shows a longitudinal section through the suspension strut in FIG. 1,

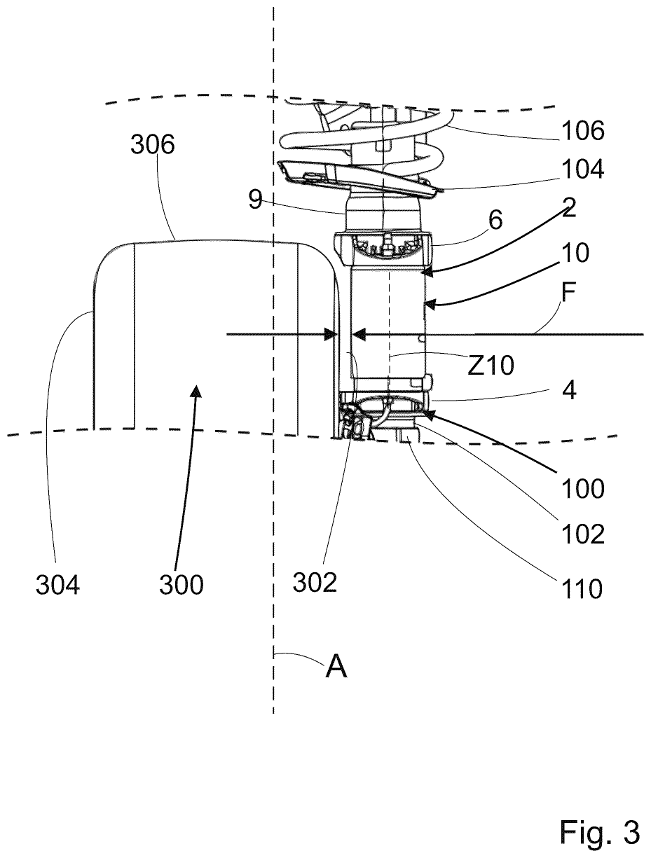

FIG. 3 shows an assembled position at the suspension strut in FIG. 1, and

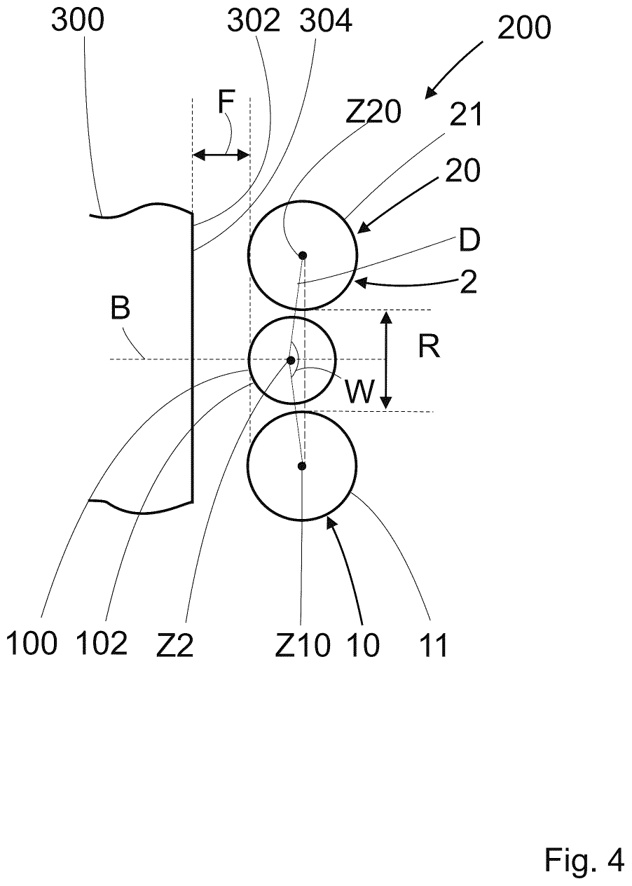

FIG. 4 shows a cross section through the installed position of the suspension strut in FIG. 3.

In the figures, elements that are identical or correspond to one another are each denoted by the same reference signs and are therefore not described again, unless expedient to do so. To avoid repetitions, features that have already been described are not described again and can be applied to all elements with the same or mutually corresponding reference signs, unless explicitly excluded. The disclosures in the entire description can be applied mutatis mutandis to identical parts with the same reference signs or the same component designations. The position indications, e.g. top, bottom, lateral etc. selected in the description also relate to the figure immediately being described or illustrated and can be applied mutatis mutandis to the new position if there is a change in position. Moreover, individual features or combinations of features in the different exemplary embodiments shown and described may also represent independent inventive solutions or solutions according to the invention.

FIGS. 1 to 4 show an identical suspension strut 100. The suspension strut 100 is a MacPherson suspension strut.

The suspension strut 100 comprises a damper 102, a spring plate 104 and a spring 106 configured as a coil spring. FIG. 1 also shows a suspension strut tower 108 of a body. FIG. 3 shows a wheel carrier 110. The damper 102 is firmly connected to the wheel carrier 110 in the manner typical of MacPherson systems. The damper 102 is traversed along its longitudinal direction by a damper longitudinal axis Z2. The spring plate 104 is arranged movably on the damper 102. The spring 106 is supported between the spring plate 104 and the suspension strut tower 108. FIG. 3 furthermore shows a tyre 300 having a side wall 302. The tyre 300 is mounted on a rim 304 and can be steered about a steering axis A as well as being rotatable about an axis of rotation B. The tyre 300 and the rim 304 define a wheel. The suspension strut 100 guides the wheel.

The suspension strut 100 also comprises a single foot point adjustment device 2. The foot point adjustment device 2 is traversed by the damper longitudinal axis Z2. It comprises a first actuator 10 having a first actuator longitudinal axis Z10 and a second actuator 20 having a second actuator longitudinal axis Z20. The first actuator 10 and the second actuator 20 are separate actuators. The damper longitudinal axis Z2 extends parallel to the direction of adjustment of the foot point adjustment device 2. The two actuator longitudinal axes Z10, Z20 extend parallel to one another and also parallel to the damper longitudinal axis Z2. The two actuator longitudinal axes Z10, Z20 are furthermore both arranged radially offset with respect to the damper longitudinal axis Z2. The actuators 10, 20 are placed radially adjacent with respect to the damper 102.

The two actuator longitudinal axes Z10, Z20 and the damper longitudinal axis Z2 form a triangle D in cross section. The two sides of the triangle between each of the damper longitudinal axes Z10, Z20 and the actuator longitudinal axis Z2 enclose an angle W in the range of from 179° to 160°. The tyre 300 and the rim 304 lie diametrically opposite the triangle D with respect to the damper longitudinal axis Z2.

The two actuators 10, 20 are hydraulic actuators and are structurally identical. On each of the two actuators 10, 20, a variable-volume fluid space 19, 29 which allows a defined target height H to be adopted is created by means of a bellows 13, 23. Each of the two actuators 10, 20 has a separate housing 11, 21, which is largely formed by the supporting tube 16, 26, wherein the housings 11, 21 are at a radial distance R from one another. The two housings 11, 21 form an intermediate space. The damper 102 is arranged in the intermediate space. The damper 102 is therefore taken past the actuators 10, 20 instead of being passed through a known and single actuator, which then surrounds the damper at the outer circumference.

The two actuators 10, 20 are connected in parallel, this being effected structurally in the embodiment shown by means of a fixing plate 4 and an adjusting plate 6. The actuators 10, 20 are arranged between the plates 4, 6 and are thereby positively coupled.

At one end, the two actuators 10, 20 are connected to the common fixing plate 4 of the foot point adjustment device 2. The two actuators 10, 20 are supported against the fixing plate 4. The fixing plate 4 is fixed on the damper 102 and is also fixed against rotation.

At the other end, the two actuators 10, 20 are connected to the common adjusting plate 6 of the foot point adjustment device 2. The two actuators 10, 20 are supported against the adjusting plate 6. The adjusting plate 6 is guided on the damper 102 in such a way as to be adjustable along the damper longitudinal axis Z2.

The adjusting plate 6 is firmly connected to the spring plate 104 via an adjusting sleeve 9. The adjustment of the adjusting plate 6 to the target height H by the actuators 10, 20 then also directly adjusts the spring plate 104 in a corresponding manner. The adjusting plate 6 comprises a sliding means 7, which supports the adjusting plate 6 on the damper 102 as it slides along the damper longitudinal axis Z2. The sliding means 7 is arranged in a cylindrical section of the adjusting plate 6.

Each of the two actuators 10, 20 has an attachment plate 12, 22. The attachment plates 12, 22 are fastened to the adjusting plate 6 and are thus adjustable.

Each actuator 10, 20 comprises a single bellows 13, 23, which is configured as a rolling bellows. Each bellows 13, 23 delimits a fluid space 19, 29 at the inner and outer circumference. The fluid space 19, 29 is delimited exclusively by the attachment plate 12, 22, a rolling piston 17, 27 and the bellows 13, 23. At one end, each bellows 13, 23 is fastened to the attachment plate 12, 22 by way of a first bellows fastening 133, 233 and, at the other end, is fastened to the rolling piston 17, 27 by means of a second bellows fastening 134, 234. Each bellows 13, 23 forms a rolling fold 131, 231 and a stationary fold 132, 232.

The stationary fold 132, 232 of the bellows 13, 23 is arranged around the outer circumference of the first bellows fastening 133, 233. The fluid space 19, 29 is therefore arranged on the outer circumference of the first fastening 133, 233, with the result that the internal pressure of the fluid space 19, 29 presses on the first fastening 133, 233. Each bellows 13, 23 is supported at the outer circumference by the respective supporting tube 16, 26. The supporting tube 16, 26 is fastened to the corresponding attachment plate 12, 22 and is thus adjustable.

One fold seat 121, 221 per actuator 10, 20 is formed by the respective attachment plate 12, 22. The stationary fold 132, 232 rests against the fold seat 121, 221. The fold seat 121, 221 comprises an arched annular surface, which, with respect to the respective actuator longitudinal axis Z10, Z20, is delimited radially on the inside by the first bellows fastening 133, 233 and radially on the outside by the contact end between the stationary fold 132, 232 and the attachment plate 12, 22.

Each of the two actuators 10, 20 comprises the respective rolling piston 17, 27, on which the respective bellows 13, 23 rolls via its rolling fold 131, 231. Each rolling piston 17, 27 has a bulging section 171, 271, the outside diameter of which is larger in a region which is located adjacent to the rolling fold 131, 231 of the corresponding bellows 13, 23 along the respective actuator longitudinal axis Z10, Z20 than the zenith of the rolling fold 131, 231. The respective rolling piston 17, 27 forms a sliding bearing assembly with the corresponding supporting tube 16, 26, there being a clearance fit. The supporting tube 16, 26 has a free end 161, 261, which is provided with sliding support on the bulging section 171, 271.

Each rolling piston 17, 27 forms an end stop 8, in each case comprising stop surfaces 122, 172, 222, 272 of the rolling piston 17, 27 and the attachment plate 12, 22. When the stop surfaces 122, 222, 172, 272 are in contact, the rolling pistons 17, 27 can project at least partially into the supporting tubes 16, 26, wherein a distance of at most 10 mm is established.

Each of the two actuators 10, 20 can comprise a valve or a hose connector 18, 28 for filling and emptying the respective fluid space 19, 29. The valve or the hose connector 18, 28 is fastened firmly to the fixing plate 4, which, for its part, is fixed firmly to the damper and at rest relative to the wheel carrier.

An assembly 200 comprises the foot point adjustment device 2, the tyre 300 with its side wall 302, which faces the foot point adjustment device 2, and the rim 304. The two actuators 10, 20 are arranged radially adjacent to the side wall 302 and/or the rim 304. The two actuators 10, 20 each have a radial clearance F with respect to the side wall 302 and/or the rim 304 of at least 10 mm. The damper 100 also has a radial clearance F with respect to the side wall 302 and/or the rim 304 of at least 10 mm. In the present case, the radial clearances F are identical. The wheel has a steering axis A, about which it is steered, and an axis of rotation B, about which it rolls.

The foot point adjustment device 2 is arranged on one side of a spring plate 104, and the spring 106 is arranged on the other side of the spring plate 104. The foot point adjustment device 2 is arranged in a space-saving manner below the spring plate 104 and next to the tyre 300 and/or the rim 304 in the horizontal direction (in each case based on an installed position in the motor vehicle).

The invention is not restricted to the embodiments described above but can be modified in a variety of ways. All the features and advantages that emerge from the claims, the description and the drawing, including design details, spatial arrangements and method steps, may be essential to the invention either in themselves or in a very wide variety of combinations.

The scope of the invention includes all combinations of at least two of the features disclosed in the description, the claims and/or the figures.

To avoid repetitions, features disclosed in respect of the device should be deemed to be also disclosed and claimable in respect of the method. Likewise, features disclosed in respect of the method should be deemed to be disclosed and claimable in respect of the device.

### LIST OF REFERENCE SIGNS

| | | | |
|---|---|---|---|
| 2 | foot point adjustment device | A | steering axis |
| 4 | fixing plate | B | axis of rotation |
| 6 | adjusting plate | D | triangle |
| 7 | sliding means | F | radial clearance |
| 8 | end stop | H | target height |
| 9 | adjusting sleeve | R | radial distance |
| 10 | actuator | W | angle |
| 11 | housing | Z2 | damper longitudinal axis |
| 12 | attachment plate | Z10 | actuator longitudinal axis |
| 121 | fold seat | Z20 | actuator longitudinal axis |
| 122 | stop surface | | |
| 13 | bellows | | |
| 131 | rolling fold | | |
| 132 | stationary fold | | |
| 133 | (first) fastening | | |
| 134 | (second) fastening | | |
| 16 | supporting tube | | |
| 161 | free end | | |
| 17 | rolling piston | | |
| 171 | bulging section | | |
| 172 | stop surface | | |
| 18 | valve | | |
| 19 | fluid space | | |
| 20 | actuator | | |
| 21 | housing | | |
| 22 | attachment plate | | |
| 221 | fold seat | | |
| 222 | stop surface | | |
| 23 | bellows | | |
| 231 | rolling fold | | |
| 232 | stationary fold | | |
| 233 | (first) fastening | | |
| 234 | (second) fastening | | |
| 26 | supporting tube | | |
| 261 | free end | | |
| 27 | rolling piston | | |
| 271 | bulging section | | |
| 272 | stop surface | | |
| 28 | valve | | |
| 29 | fluid space | | |
| 100 | suspension strut | | |
| 102 | damper | | |
| 104 | spring plate | | |
| 106 | spring | | |
| 108 | suspension strut tower | | |
| 110 | wheel carrier | | |
| 200 | assembly | | |
| 300 | tyre | | |
| 302 | side wall | | |
| 304 | rim | | |
| 306 | running surface | | |

1. Foot point adjustment device (2), through which a damper longitudinal axis (Z2) can pass, comprising a first actuator (10) having a first actuator longitudinal axis (Z10) and a second actuator (20) having a second actuator longitudinal axis (Z20).

2. Foot point adjustment device (2) according to claim 1, characterized in that the two actuator longitudinal axes (Z10, Z20) are arranged parallel to one another.

3. Foot point adjustment device (2) according to claim 1, characterized in that the two actuators (10, 20) are at a radial distance (R) from one another.

4. Foot point adjustment device (2) according to claim 1, characterized in that the two actuators (10, 20) are connected to a fixing plate (4), the fixing plate (4) preferably being fastened to a damper (102).

5. Foot point adjustment device (2) according to claim 1, characterized in that the two actuators (10, 20) are connected to an adjusting plate (6), the adjusting plate (6) preferably being guided on a damper (102) in such a way as to be adjustable along the damper longitudinal axis (Z2).

6. Foot point adjustment device (2) according to claim 5, characterized in that a respective attachment plate (12, 22) is fastened to the adjusting plate (6) for each of the two actuators (10, 20).

7. Foot point adjustment device (2) according to claim 1, characterized in that the two actuators (10, 20) are structurally identical.

8. Foot point adjustment device (2) according to claim 1, characterized in that each of the two actuators (10, 20) comprises a bellows (13, 23).

9. Foot point adjustment device (2) according to claim 1, characterized in that each of the two actuators (10, 20) comprises a supporting tube (16, 26), the respective bellows (13, 23) preferably being supported at the outer circumference by the respective supporting tube (16, 26).

10. Foot point adjustment device (2) according to claim 8, characterized in that each of the two actuators (10, 20) comprises a rolling piston (17, 27), the respective rolling piston (17, 27) preferably forming a sliding bearing assembly with the corresponding supporting tube (16, 26).

11. Foot point adjustment device (2) according to claim 1, characterized in that the fixing plate (4) is firmly connected to the damper (102).

12. Assembly (200), comprising
a foot point adjustment device (2) according to claim 1 and
a tyre (300) having a side wall (302) and
a rim (304), wherein
the two actuators (10, 20) and the damper (100) are arranged radially adjacent to the side wall (302) and/or the rim (304), and
each has a radial clearance (F) with respect to the side wall (302) and/or the rim (304) of at least 10 mm, preferably of at least 15 mm.
